(19) United States
(12) Patent Application Publication
(10) Pub. No.: US 2026/0160440 A1
(43) Pub. Date: Jun. 11, 2026

(54) DEMAND RESPONSE EVENTS WITH LOAD SHAPE BASED ON GROUPED DEVICES

(71) Applicant: EnergyHub, Inc., Brooklyn, NY (US)

(72) Inventors: Paul Douglas Harper Hines, Burlington, VT (US); Matthias Huels, Brooklyn, NY (US)

(21) Appl. No.: 19/318,984

(22) Filed: Sep. 4, 2025

Related U.S. Application Data
(60) Provisional application No. 63/696,888, filed on Sep. 20, 2024.

(51) Int. Cl. F24F 11/64; F24F 11/54; G05B 15/02

(52) U.S. Cl. CPC F24F 11/64; F24F 11/54; G05B 15/02

(57) ABSTRACT

Methods, systems, and apparatus, including computer programs encoded on computer storage media, for load shaping for a demand response event using multiple device group thermal models. One of the methods includes maintaining, for a thermostat group, a thermal model that a) represents an average thermal behavior of thermostats in the thermostat group, and b) includes a plurality of parameters that define a sigmoid-like function; providing, as input to a schedule optimizer, i) a target load constraint and ii) the thermal model for each of a plurality of thermostat groups and that includes the plurality of parameters; receiving, as output from the schedule optimizer, a thermostat group schedule for one or more thermostats; and in response to receiving the thermostat group schedule, transmitting, to each of the one or more thermostats, commands to cause the corresponding thermostat to execute the corresponding thermostat group schedule.

### CLAIM OF PRIORITY

This application claims the benefit of U.S. Provisional Application Ser. No. 63/696,888, filed on Sep. 20, 2024. The entire contents of the foregoing are incorporated herein by reference.

### BACKGROUND

The electrical grid comprises a variety of infrastructure components, including power stations, substations, transformers, distribution feeder cables, and transmission lines that provide energy to various energy consuming devices in different geographical regions. These infrastructure components can provide energy to the various energy consuming devices at any appropriate time, such as when electricity is plentiful or inexpensive, or demand is low or, alternatively, when electricity demand is high. Some examples of the energy consuming devices can include heating, ventilation, and air conditioning (“HVAC”) units, ovens, food cooling systems, e.g., refrigeration systems and freezing systems, electric vehicle charging devices, smart phones, and lights.

### SUMMARY

In general, one aspect of the subject matter described in this specification can be embodied in methods that include the actions of maintaining, in memory and for each thermostat group in a plurality of thermostat groups, a thermal model that a) represents an average thermal behavior of thermostats in the thermostat group, and b) includes a plurality of parameters that define a sigmoid-like function that maps changes in a difference between indoor temperature and temperature set point for the thermostat group to a relative power consumption of the thermostat group; providing, as input to a schedule optimizer, i) a target load profile for multiple thermostat groups from the plurality of thermostat groups and ii) the thermal model for each of the plurality of thermostat groups and that includes the plurality of parameters; receiving, as output from the schedule optimizer and for each of two or more thermostat groups from the plurality of thermostat groups, a thermostat group schedule for one or more thermostats in the corresponding thermostat group; and in response to receiving the thermostat group schedule, transmitting, to each of the one or more thermostats, commands to cause the corresponding thermostat to execute the corresponding thermostat group schedule.

In general, one aspect of the subject matter described in this specification can be embodied in methods that include the actions of, for each thermostat group of a plurality of thermostat groups: maintaining, for each of one or more thermostats in a thermostat group, historical data for historical demand response events that the thermostat participated in and includes historical relative power consumption data that indicates one or more historical relative power consumption cycles for the thermostat; training a thermal model to simulate an average relative power consumption for the thermostat group using, as input, the historical data by modifying the plurality of parameters of the thermal model; and storing, in memory, the plurality of parameters as the thermal model that a) represents the average thermal behavior of the thermostats in the thermostat group, and b) includes the plurality of parameters that define the sigmoid-like function and were generated using a training process.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination.

In some implementations, providing the input to the schedule optimizer can include providing, at input to the schedule optimizer, controllability data that identifies a controllability of at least some of the thermostats in the plurality of thermostat groups. Receiving the thermostat group schedule can include receiving the thermostat group schedule that was generated using the controllability data.

In some implementations, for at least a first thermostat group from the plurality of thermostat groups, the thermal model can be a sigmoid approximation of the relative power consumption as a function of: an average difference t, for two or more thermostats in the thermostat group, between an indoor temperature of a region of a building relative to set point for the respective thermostat for the region; a sharpness k; a minimum sigmoid limit γ; and a maximum sigmoid limit κ.

In some implementations, the method can include generating, as the thermal model, a reduced-order, linearized thermal model using a piece-wise linear switching function.

In some implementations, generating the thermal model can include generating, using a recurrent neural network training process, the plurality of parameters of the thermal model represented by one or more weights.

In some implementations, the thermal model, a) for a thermostat group from the plurality of thermostat groups and b) that includes the plurality of parameters, might have been trained using property data for a proper subset of thermostats in the thermostat group that does not include all thermostats in the thermostat group.

In some implementations, the thermal model, a) for a thermostat group from the plurality of thermostat groups and b) that includes the plurality of parameters, might have been trained using historical data for a proper subset of thermostats in the thermostat group that does not include all thermostats in the thermostat group.

In some implementations, the historical data can include setpoint data for one or more first thermostats in the thermostat group and might not include setpoint data for one or more second, different thermostats in the thermostat group.

In some implementations, providing the input to the schedule optimizer can include providing, as the input to the schedule optimizer, i) the target load profile for the multiple thermostat groups, ii) the thermal model for each of the plurality of thermostat groups and that includes the plurality of parameters, and iii) one or more non-thermostat device group models. Receiving the output can include receiving, as the output from the schedule optimizer and for each of the two or more thermostat groups from the plurality of thermostat groups, a thermostat group schedule.

In some implementations, providing the input to the schedule optimizer can include providing, as the input to the schedule optimizer, i) the target load profile for the multiple thermostat groups, ii) the thermal model for each of the plurality of thermostat groups and that includes the plurality of parameters, and iii) one or more non-thermostat device group models. Receiving the output can include receiving, as the output from the schedule optimizer and for each of the two or more thermostat groups from the plurality of thermostat groups, a thermostat group schedule.

In some implementations, the method can include generating, using a grouping algorithm, the thermostat groups of the plurality of thermostat groups by: comparing, for each of at least some thermostats from a plurality of thermostats, a parameter of the corresponding thermostat to a similarity threshold, and, grouping, using a result of the comparing, a two or more thermostats from the plurality of thermostats into a thermostat group of the plurality of thermostat groups.

In some implementations, the parameter of the plurality of thermostats can include a runtime trend during prior DR events, an amount of time that a measured indoor temperature takes to go from a person setpoint value to a new setpoint after a DR event, or a frequency at which a thermostat opts-out of a DR event.

In some implementations, the method can include providing, as input to the schedule optimizer, iii) a cost term representing a difficulty of one or more thermostat groups to satisfy an objective of the target load constraint, and wherein the schedule optimizer generates the thermostat group schedule by determining a minimum of the cost term which satisfies the objective.

In some implementations, the plurality of parameters can include one or more of a sharpness k, a minimum sigmoid limit γ, a maximum sigmoid limit κ, a midpoint shift μ that shifts the midpoint of a switching function for the thermal model, a connected load power Qₘₐₓ, an average thermal resistance R for the thermostat group, an average thermal capacity Ĉ for the thermostat group, or an average initial reference setpoint \hat{T}_{set,0} for the thermostat group.

In some implementations, the plurality of parameters can include one or more of a sharpness k, a minimum sigmoid limit γ, a maximum sigmoid limit κ, a midpoint shift μ that shifts the midpoint of a switching function for the thermal model, a connected load power Qₘₐₓ, an average thermal resistance \hat{R} for the thermostat group, an average thermal capacity Ĉ for the thermostat group, or an average initial reference setpoint \hat{T}_{set,0} for the thermostat group.

In some implementations, the one or more thermostats can be one or more first thermostats. The method can include, for each thermostat group of a plurality of thermostat groups: maintaining, for each of one or more second thermostats in the thermostat group, historical data for historical demand response events that the second thermostat participated in and includes historical relative power consumption data that indicates one or more historical relative power consumption cycles for the second thermostat; training the thermal model to simulate an average relative power consumption for the thermostat group using, as input, the historical data by modifying the plurality of parameters of the thermal model; and storing, in memory, the plurality of parameters as the thermal model that a) represents the average thermal behavior of the thermostats in the thermostat group, and b) includes the plurality of parameters that define the sigmoid-like function and were generated using a training process.

In some implementations, training the thermal model can include training the thermal model that has, for one or more nodes representing a parameter from the plurality of parameters included in the thermal model, an activation function based on a combination of the sharpness k, the minimum sigmoid limit γ, the maximum sigmoid limit κ, and the midpoint shift μ.

In some implementations, the activation function can be based on, as input, at least some of the plurality of parameters and τ=T−Tₛₑₜ for an indoor temperature T of a region of a building and a thermostat setpoint Tₛₑₜ.

In some implementations, the method can include selecting, for a thermostat group from the plurality of thermostat groups, two or more thermostats for the thermostat group using, for each of the two or more thermostats, a physical location of corresponding thermostat.

In some implementations, the method can include maintaining, for each of one or more third thermostats in the thermostat group, property data for a region of a building in which the third thermostat controls temperature. Training the thermal model can use the property data as input.

The subject matter described in this specification can be implemented in various implementations and may result in one or more of the following advantages. In some implementations, the systems and methods described in this specification can enable a more accurate load shape for a group of devices, e.g., thermostats, HVAC systems, other devices and systems, or any combination of these, compared to other systems using a thermal model, a schedule optimizer, or both. For instance, a system can shape the load from groups of systems, e.g., HVAC systems, distributed energy resources, or both, where each of the individual groups of systems is highly constrained in its behavior, e.g., only allowing a thermostat setpoint adjustment. This can enable the system to more accurately shape the load given one or more objectives, used by the schedule optimizer, compared to other systems. The objectives can include a target load profile.

In some implementations, the systems and methods described in this specification can more quickly, more efficiently, or both, generate thermal models, group schedules, or both, using a piece-wise linear switching function. For instance, by using a piece-wise linear group model, a system can use a mixed integer optimization system to quickly find solutions to the load shaping or virtual power plant problem, which solution would otherwise be highly nonlinear, expensive, time-consuming, or any combination of these, or even potentially impossible to solve.

In some implementations, the systems and methods described in this specification can more accurately, more quickly, using fewer computational resources, or any combination of these, generate a thermal model by using a recurrent network training process compared to other systems. In some implementations, the systems and methods described in this specification can minimize a peak load, shape a load to balance renewable energy supply, minimize an amount of energy used when energy resources are more constrained, e.g., given market energy usage, or any combination of these, by transmitting commands to thermostats based on a thermostat group schedule generate using the described thermal model. In some implementations, by generating, for each of two or more thermostat groups from multiple thermostat groups, a thermostat group schedule for one or more thermostats in a corresponding thermostat group, the systems and methods described in this specification can more evenly distribute a load for a demand response event compared to other systems.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts an example environment that includes a demand response control system that generates a schedule for a thermostat.

FIG. 2 depicts an example graph with multiple load profiles.

FIG. 3 depicts an example of a model generation engine.

FIGS. 4A-C depict graphs.

FIG. 5 is a flow diagram of an example process for using a thermal model.

FIG. 6 is a block diagram of a computing system that can be used in connection with computer-implemented methods described in this specification.

Like reference numbers and designations in the various drawings indicate like elements.

### DETAILED DESCRIPTION

Some heating, ventilation, and air conditioning (“HVAC”) thermostat demand response (“DR”) events are called by specifying a “thermostat offset”. For example, a system can specify a cooling DR event that has a two degree decrease in temperature setpoint for a 90-minute pre-cool period before the DR event, and then a four degree increase in setpoint for a 3-hour period during the DR event. After the DR event, the thermostat can return to its original setpoint. However, this type of DR event can result in a load shape with an uneven amount of load reduction over the DR event period. For instance, this type of DR event can result in a load shape with more load reduction at the beginning of the DR event, across all thermostats, and less load reduction at the end of the DR event. As a result, this can cause unnecessary strain on an electric grid that supplies energy to the corresponding HVACs for the DR event.

In some instances, this load shape might not satisfy one or more objectives, e.g., defined by a utility or other virtual power plant (“VPP”) operator. These objectives can include minimizing expected net load during a potentially unknown coincident peak hour, spreading load shed evenly over a set of hours, minimizing the snap-back load after the event concludes, spreading out the snap-back load after the event concludes, counteracting the load shape of a solar ramping event, balancing the variability in renewables, shaping load in response to forecasted or real-time energy supply (e.g., wholesale market price signals), or any combination of two or more of these. The thermostat offset load shape, e.g., alone, might not account for one or more of these objectives.

To increase a likelihood that at least some of these objectives are satisfied for a DR event, a demand response control system can control two or more thermostat groups to deliver a pre-specified load shape or VPP output. Each thermostat group can include two or more thermostats or other types of devices. For instance, the demand response control system can maintain, for each thermostat group, a thermal model that represents the thermostats in the group. In some instances, a thermostat group, or multiple thermostat groups or combinations of other devices, can represent a virtual power plant for which the demand response control system can generate a specific load shape for the objectives.

An optimizer can generate a system schedule for the thermostat groups, or separate group schedules for each thermostat group, using the thermal models for the thermostat groups, a target load profile, and, optionally, data about the DR event. The system schedule can include multiple group schedules, one for each of the thermostat groups. The multiple group schedules combined can have the specific load shape for the objectives, e.g., the group schedules can affect the behavior of the thermostats and other devices to simulate a virtual power plant given at least some of the objectives. A thermal model can represent multiple parameters for a corresponding thermostat group, e.g., a sharpness k, a minimum sigmoid limit γ, a maximum sigmoid limit κ, a load u, a connected load power Qₘₐₓ, an average thermal resistance \hat{R} for the thermostat group, an average thermal capacity Ĉ for the thermostat group, or an average initial reference setpoint \hat{T}_{set,0} for the thermostat group. The optimizer can then send commands to the thermostat groups to cause the thermostats in the groups to run according to the system schedule. The command can cause one or more thermostats in a single thermostat group to execute the corresponding group schedule.

The demand response control system, or another system, can generate the thermal models using a recurrent neural network training process, as described in more detail below. For instance, the demand response control system can use historical data, property data, or both, to train a thermal model to mirror a duty cycle, HVAC power consumption, or both, from a thermostat group. The demand response control system can use the weights trained using the recurrent neural network training process as at least part of the thermal model for the corresponding thermostat group, e.g., as parameters for the thermal model.

The demand response control system can use thermal models of device groups instead of single devices to more accurately generate schedules for the devices to execute. For instance, any particular device might be offline, or otherwise not accept a command from the demand response control system. By modeling groups of devices that each have a size, e.g., the same size, that satisfies a size threshold, the thermal model can more accurately represent the devices in the group. As a result, if any particular group is offline or not operating as it might otherwise during a particular time period, e.g., when a resident is on vacation and adjusted their thermostat setpoint, the thermal model represents a sufficient quantity of devices, e.g., at least 500 devices, to account for these changes.

In this specification, relative power consumption can refer to a duty cycle, HVAC power consumption, or both. Although some examples might refer to one or the other of a duty cycle or HVAC power consumption, similar examples equally apply to the other or a combination of both.

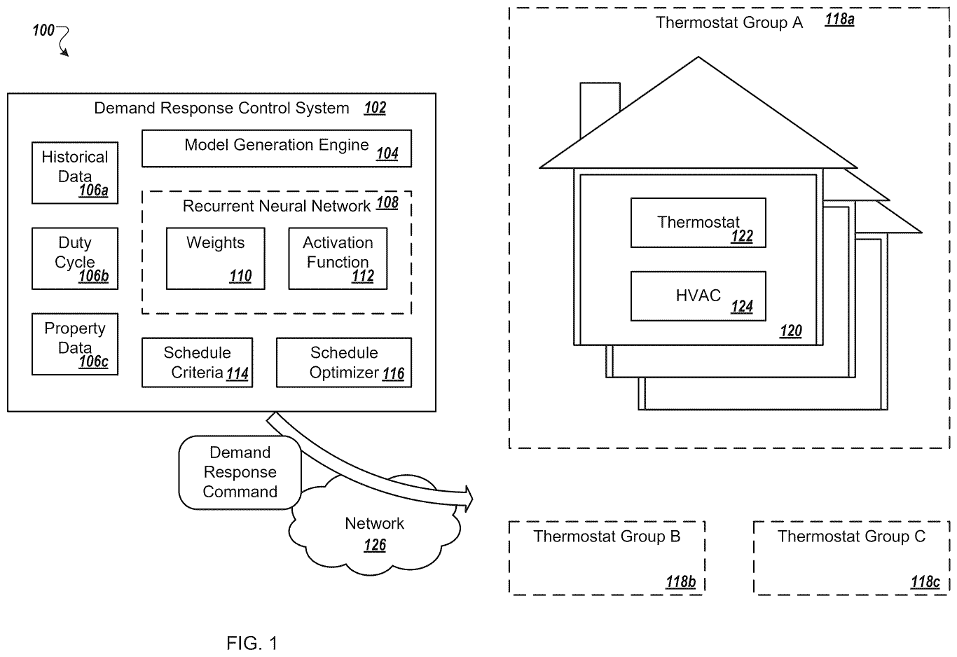

FIG. 1 depicts an example environment that includes a demand response control system 102 that generates a schedule for a thermostat. The demand response control system 102 generates schedules for thermostat groups 118. The schedule can indicate times when a corresponding thermostat in the thermostat group should change the thermostat's set point. The changes to the set point can include an increase, a decrease, or a combination of both. The demand response control system 102 can generate the schedules to satisfy one or more schedule criteria, such as a target load shape, one or more limits for a number of thermostat set point changes for a schedule, a DR event, or a combination of both, predicted energy availability, or any combination of these. The demand response control system 102 can be an example of a distributed energy resource management system (“DERMS”).

The demand response control system 102 includes a model generation engine 104, described in more detail below. The model generation engine 104 can use one or more types of model generation input data 106a-c to generate a thermal model that represents an average thermal behavior of multiple thermostats in a thermostat group. The model generation input data 106a-c can include any appropriate type of input data, e.g., training data, such as historical data 106a, duty cycle data 106b, property data 106c, or any combination of these.

The historical data 106a can include historical weather data, e.g., outdoor temperature and humidity data; historical connected load data, e.g., connected load power data; historical power consumption data; historical duty cycle data; historical state change data; participation data for past DR events; or any combination of these. The data can be from historical time periods that included DR events, that did not include any DR events, or a combination of both. In some instances, the historical data 106a might not include reference setpoint data, indoor temperature data, or both, e.g., when such data is unavailable for a building 120 in a thermostat group 118 or otherwise unavailable in general. Data that indicates participation in past DR events can indicate whether a corresponding thermostat is controllable for DR events.

In some examples, the historical data can be an indirect measure of customer discomfort. Customer discomfort can be an objective for minimizing expected net load. Customer discomfort can be inferred by using the historical data to determine one or more discomfort thresholds. In some examples, the discomfort thresholds can include a frequency of a customer opting out, a relative frequency of a customer opting out compared to another customer, an amount of time that an internal temperature of an area in which a thermostat is installed varies from a customer-chosen setpoint, a trend in thermostat run-time data, or a combination of these.

The duty cycle data 106b can indicate the average duty cycle for a thermostat or thermostats in a thermostat group 118, e.g., during past DR events. The duty cycle data 106b can be a type of the historical data 106a. The duty cycle data 106b can include other types of relative power consumption data, e.g., HVAC power consumption data.

The property data 106c can be any appropriate type of data that is specific to a property, thermostat, or combination of both. For instance, property data can include a thermal resistance R for a property, a thermal capacity C for a property, a reference setpoint for a thermostat, whether initial or otherwise, or any combination of these. In some instances, the demand response control system 102 might not have any property data 106c for any thermostats in a thermostat group 118, might have property data 106c for only a proper subset of thermostats in a thermostat group, or a combination of both. For instance, the demand response control system 102 might have property data 106c for some thermostats in a thermostat group B 118b and no property data 106c for any thermostats in a thermostat group C 118c. In these instances, the demand response control system 102 can use the property data 106c to which it has access to infer predicted property data for other buildings for which property data is unavailable.

The thermal model is specific to a thermostat group 118. For example, the demand response control system 102 would maintain a first thermal model for a thermostat group A 118a, a second thermal model for the thermostat group B 118b, and so on.

The demand response control system 102 can generate a thermostat group, or multiple thermostat groups, using a grouping algorithm. The grouping algorithm can determine a group of devices which satisfy a similarity criterion. In some examples, the grouping algorithm can be a k-means, or a spectral clustering algorithm. The similarity threshold can be determined, or maintained, by the demand response control system 102. The demand response control system 102 can use the grouping algorithm to compare one or more parameter or one or more thermostats to the similarity criterion. If the parameter of the one or more thermostats satisfies the similarity criterion, the demand response control system 102 can group the thermostat with other thermostats which satisfy the same similarity criterion.

Examples of the similarity criterion can include runtime trends during prior DR events, an amount of time that a measured indoor temperature takes to go from a first setpoint value to a second setpoint after a DR event, a frequency at which a device ‘opts-out’ of a DR event, or a combination of these. In some examples, in an opt-out event a person can operate the thermostat during a DR event to change the temperature setpoint from the temperature setpoint determined for the DR event by the demand response control system 102.

The thermal models can receive input and, in response, generate output. Some examples of input data for a thermal model can include weather forecast data, historical thermostat data, current thermostat data, an estimate of a baseline future load, one or more setpoint changes, an estimate of controllability, or any combination of these. Thermostat data can include runtime data, participation data, power consumption data, or any combination of these. The estimate of the baseline future load can indicate a predicted runtime load when none of the thermostats in the thermostat group 118 are controlled by the demand response control system 102. The predicted runtime load can be expressed in average runtime for the thermostat group; aggregate, average, or combination of both, power for the thermostat group; or any combination of both. In some examples, a thermal model can be used to estimate a future baseline future load for the corresponding thermostat group given the other types of input data; to compute a load difference from the estimated future baseline load given a potential setpoint adjustment, e.g., when another forecasting system generates the baseline; or a combination of both.

The thermal models can predict a change in HVAC load. For instance, the thermal model can output data indicating a change in the runtime load relative to the baseline. The thermal model can predict the change in load predicted to result from a setpoint adjustment. For example, if the demand response control system 102 increases the setpoint by four degrees for the period from 3 μm to 6 μm, the prediction can indicate how the load might change over a time period, e.g., from 3-8 μm. The change can indicate how much more, or how much less load is used by the devices represented by the model, e.g., the thermostats, HVACs, or both.

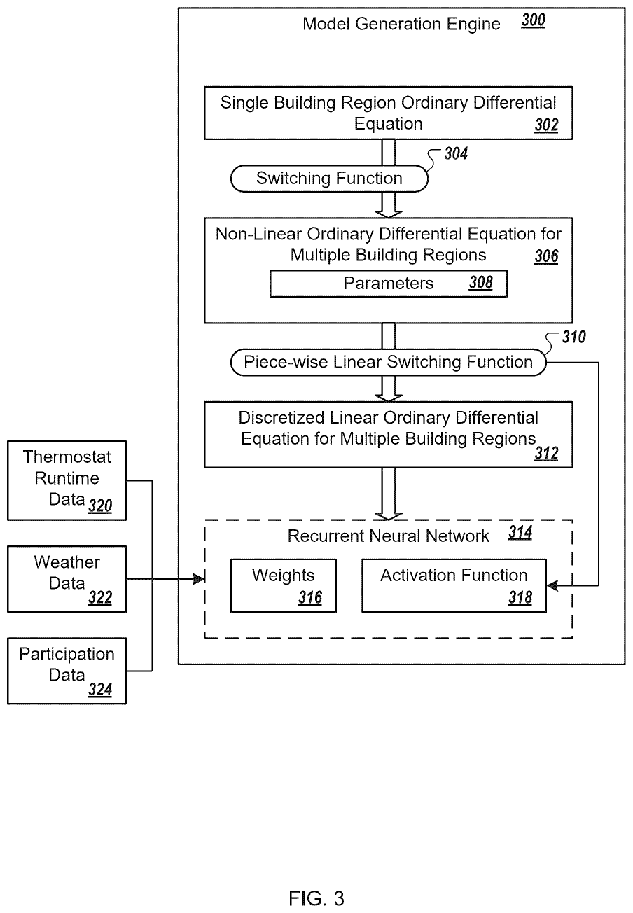

The thermal model includes multiple weights 110. The model generation engine 104 can generate the weights 110 using a recurrent neural network training process that trains a recurrent neural network 108, that includes the weights 110, e.g., representing parameters of the thermal model, and an activation function 112, as described in more detail below with references to FIG. 3. The model generation engine 104 can use any appropriate type of recurrent neural network training process to train the recurrent neural network 108.

The demand response control system 102 can maintain one or more schedule criteria 114. The schedule criteria 114 can include one or more objectives, e.g., defined by an energy provider, one or more constraints, or a combination of both. Some examples of constraints can include one or more limits for a number of setpoint changes, a target load shape, or both.

The one or more limits for a number of set point changes can include a maximum number of changes, a minimum number of changes, a maximum change amount, a minimum change amount, or any combination of these. A change amount can restrict an amount by which a setpoint for a thermostat can be changed during a schedule generation process.

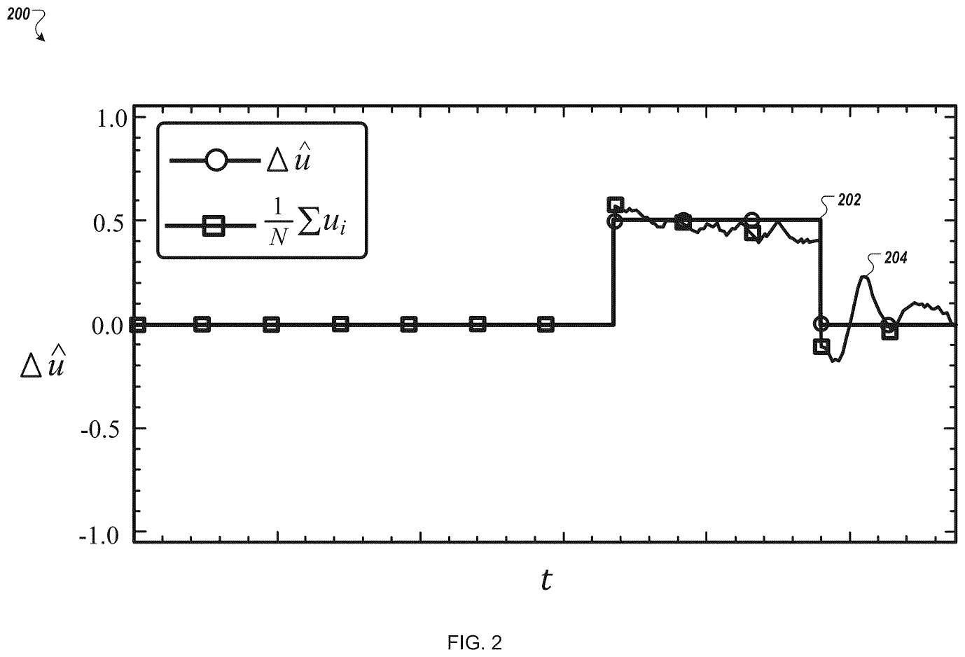

FIG. 2 depicts an example graph 200 with multiple load profiles. The graph 200 includes a target load profile 202. The target load profile 202 can be for a particular DR event, all DR events, e.g., for a particular energy provider, or for a group of DR events.

The demand response control system 102, or another system, can generate the target load profile 202. For instance, the system can include an optimizer that uses one or more load profile objectives to generate the target load profile. At least some of the load profile objectives can be defined by one or more corresponding constraints. The one or more load profile objectives can be to minimize a peak load, minimize an amount of energy used when energy resources are more constrained, e.g., given market energy usage, or both. In some examples, the target load profile can include one or more constraints which can satisfy the one or more load profile objectives, e.g., a target load constraint.

In some examples, the objectives can include minimizing a cost term, e.g., a cost term for satisfying the objective. The cost term can be a penalty for one or more thermostat groups to satisfy the one or more objectives. The value of the cost term can be correlated to the difficulty of satisfying the objective, e.g., a high cost can be correlated to a difficult objective to satisfy. In some examples, the cost term can be applied to a thermostat group which has an average out-out rate higher than one or more other thermostat groups.

In some examples, the demand response control system 102 can update the cost term for the thermostat group using information received from the thermostat group devices. The information received can be from a DR event in which the thermostat group was dispatched. In some examples, the demand response control system 102 can update a cost term associated with a thermostat control group that has been dispatched more frequently than another thermostat control group. The demand response control system 102 can increase the cost term associated with the thermostat control group that has been dispatched more frequently. The demand response control system 102 can dispatch the thermostat control group less frequently in subsequent DR events.

The load profile objectives can include a load shed quantity term. The load shed quantity term can be a measure of the load shed, e.g., an average load shed, over an event period. The value of the load shed quantity term can be correlated to how much load can be shed by the optimizer over the event period. For instance, a high value can be correlated to a high load shed quantity compared to an event period criteria, e.g., high compared to a total load over the event period. The demand response control system 102 can generate a target load profile 202 to maximize the load shed quantity during the event period.

The load profile objectives can include a load shed flatness term. The load shed flatness term can be a measure of a flatness of a load shed profile over an event period. The flatness of the load shed profile can be correlated to a constant rate of change of the load shed profile, e.g., a second derivative of the load shed profile which can be about zero, or a constant value of the load shed, e.g., a first derivative of the load shed profile which can be about zero. The demand response control system 102 can generate a target load profile 202 which can minimize the load shed flatness term during the event period.

In some examples, the demand response control system 102 can generate the target load profile 202 using the load shed flatness term, the load shed quantity term, or both. For terms that do not satisfy one or more corresponding criteria, the demand response control system 102 can adjust the term, e.g., the load shed flatness term, the load shed quantity term, or both.

In some instances, the demand response control system 102 can use a combination of the load shed flatness term and the load shed quantity term. For instance, the demand response control system can use a weighting term which can be a factor by which the load shed flatness term and the load shed quantity term can be balanced, e.g., adjusted. The weighting term can be a factor which can be applied to the load shed flatness term, the load she quantity term, or both. The weighting term can have a value which increases, or decreases corresponding ones of the load shed flatness term, the load shed quantity term, or both. By increasing, or decreasing, one or both of the load shed flatness term or, the load shed quantity term, the demand response control system 102 can balance the terms to satisfy the objectives.

Although the examples in this specification refer to the target load profile as examples of a load profile objective, other objectives can be used. The other objectives can include the load shed quantity term, the load shed flatness term, the weighting term, or any combination of these.

The graph 200 includes a determined load profile 204. A schedule optimizer 116 included in the demand response control system 102, shown in FIG. 1, can use the target load profile 202, as one of the schedule criteria, to generate the determined load profile 204. The schedule optimizer 116 can generate the determined load profile 204 that fits the target load profile 202 given the one or more schedule criteria 114.

When generating the determined load profile 204, the schedule optimizer 116 can generate a schedule for at least one of the thermostat groups A-C 118a-c. For instance, the schedule optimizer 116 can generate a thermostat group schedule for the thermostat group A 118a, or a system schedule that includes a thermostat group schedule for each of the thermostat groups A-C 118a-c. The system schedule can be for an energy provider that provides energy to all of the thermostats in the thermostat groups A-C 118a-c.

The schedule optimizer 116 can use any appropriate input data to generate a schedule. The input data can include controllability data that identifies a controllability of at least some of the thermostats in a thermostat group, e.g., the thermostat group A 118a, or in all thermostat groups A-C 118a-c. A person can change a setpoint of the thermostat during a DR event and thus elect to opt-out from the specific DR event. A person can un-enroll a thermostat from a DR event program in which the thermostat was previously enrolled. A DR event program can include one or more individual DR events. The controllability input data can include data representing whether a thermostat is enrolled in a DR event program; whether a thermostat has been opted-out from one or more individual DR events, e.g., whether a set point of the thermostat has been changed during one or more individual DR events; or a combination of these.

The input data can include the target load profile, e.g., for all thermostat groups A-C 118a-c when the schedule optimizer 116 generates a system schedule. The input data includes at least one thermal model for the corresponding thermostat group. In implementations in which the schedule optimizer 116 generates a system schedule, the input data can include a thermal model for each of the thermostat groups to which the system schedule applies.

In some implementations, the input data can include other types of models. For instance, when the schedule optimizer 116 generates a schedule for devices that do not include thermostats, e.g., other power consuming devices that can run intermittently such as a battery charger, the input data can include one or more non-thermostat device group models. The non-thermostat device group models can represent an average behavior of the non-thermostat devices in the corresponding non-thermostat device group.

The demand response control system 102 can use the generated schedule to transmit demand response commands to various devices using a network 126. The command can include computer instructions that cause the recipient device to execute at least a corresponding portion of the generated schedule. For instance, when the demand response control system 102 transmits a DR command to a thermostat 122 at the building 120, the thermostat 122 can adjust its setpoint according to the command. The thermostat 122 can then control a corresponding HVAC 124 for the building 120 using the adjusted setpoint.

For instance, during a cooling DR event given high temperatures outside, the DR command can indicate a setpoint decrease and a first time at which to implement the setpoint decrease. The setpoint decrease can indicate a decrease in a temperature of a region within the building 120, e.g., to cool the region. The DR command can indicate a setpoint increase and a second time, after the first time, at which to implement the set point increase. The setpoint change, whether a decrease or an increase, can be an absolute temperature, e.g., “x” degrees, or a relative change, e.g., reduce the setpoint by two degrees.

A thermostat group schedule includes schedule data for all thermostats in a corresponding thermostat group 118. For instance, a first thermostat group schedule includes schedule data for all first thermostats, e.g., the thermostat 122, in the thermostat group A 118a and a second thermostat group schedule includes schedule data for all second thermostats in the thermostat group B 118b.

The schedule data can indicate one or more times for setpoint changes. The times for setpoint changes can be the same for all thermostats in a thermostat group 118.

The schedule data can indicate setpoint changes for the thermostats in the thermostat group. In some examples, the setpoint changes can be the same for all thermostats in a thermostat group 118. This can occur when a setpoint change is a relative change. In some implementations, at least some of the setpoint changes can be different for different thermostats in the thermostat group 118. This can occur when the setpoint changes indicate absolute setpoint values.

Each of the buildings 120 can have any appropriate number of thermostats 122, HVACs 124, or a combination of both. For instance, a first building can have a single thermostat and a single HVAC. A second building can have two thermostats for different regions, e.g., zones, in the second building. The second building can have one HVAC, e.g., a multi-zone HVAC. A third building can have multiple thermostats and multiple HVACs. Each of the thermostats can control, at least in part, operation of a corresponding HVAC. The number of thermostats and the number of HVACs in the third building can be the same or different.

The schedule optimizer 116 can generate a schedule for any appropriate time period. The time period can be a 24-hour time horizon, e.g., from the start of the DR event. In some examples, the schedule optimizer 116 can use a receding horizon control, e.g., model predictive control, when generating a schedule.

The demand response control system 102 is an example of a system implemented as computer programs on one or more computers in one or more locations, in which the systems, components, and techniques described in this specification are implemented. The non-thermostat devices (not shown) can include personal computers, mobile communication devices, electric vehicles, electric vehicle batteries, other types of power storage devices, and other devices that can send and receive data over the network 126. The network 126, such as a local area network (“LAN”), wide area network (“WAN”), the Internet, or a combination thereof, connects the demand response control system 102, the devices, and the thermostats 122. The demand response control system 102 can use a single computer or multiple computers operating in conjunction with one another, including, for example, a set of remote computers deployed as a cloud computing service.

The demand response control system 102 can include several different functional components, including the model generation engine 104, the recurrent neural network 108, the weights 110, and the schedule optimizer 116. The model generation engine 104, the recurrent neural network 108, the weights 110, the schedule optimizer 116, or a combination of these, can include one or more data processing apparatuses, can be implemented in code, or a combination of both. For instance, each of the model generation engine 104, the recurrent neural network 108, the weights 110, and the schedule optimizer 116 can include one or more data processors and instructions that cause the one or more data processors to perform the operations discussed herein.

The various functional components of the demand response control system 102 can be installed on one or more computers as separate functional components or as different modules of a same functional component. For example, the components of the demand response control system 102 can be implemented as computer programs installed on one or more computers in one or more locations that are coupled to each through a network. In cloud-based systems for example, these components can be implemented by individual computing nodes of a distributed computing system.

FIG. 3 depicts an example of a model generation engine 300. The model generation engine 300 is one example of the model generation engine 104 of FIG. 1. The model generation engine 300 can use various input data to generate a thermal model that includes multiple weights 316. The weights 316 are one example of the weights 110 of FIG. 1.

The model generation engine 300 can use a recurrent neural network training process 314 to generate the weights 316. For instance, the weights 316 can have the form of recurrent neural network weights and can be determined using a recurrent neural network training process without requiring the actual use of a recurrent neural network. In some examples, the model generation engine 300 can use a model including a recurrent neural network training process 314 which can include other processes in addition to the recurrent neural network training process 314.

The model generation engine 300 can represent a building with a single-region ordinary differential equation (“ODE”) 302 or a multi-region ODE 306. The building can be any appropriate type of building that has a thermostat and a device controlled by the thermostat. The device controlled by the thermostat can be an HVAC or another appropriate type of device that generates heat, air conditioning, or both. A single-region ODE 302, e.g., a single building region, can represent a region that has a single thermostat, e.g., a home with a single thermostat and a single HVAC. A multi-region ODE 306 can represent a building that has multiple regions each of which have a separate thermostat and HVAC or a building that has single region that has multiple thermostats and fewer HVACs, e.g., at least one but some HVACs are for multiple thermostats.

The region can be any appropriate region within the building and for which the thermostat controls the temperature at least in part. For instance, the region can be a zone in the building, or an entire building.

In some examples, the model generation engine 300 can represent a group of devices, e.g., a group of devices having similar physical geographic locations, or a group of devices that sit behind congested, constrained, or both, grid assets. The model generation engine can represent the group of devices, one or more regions having one or more devices, or combinations of these.

The model generation engine 300 can use multiple ODEs, e.g., any combination of single-region ODEs 302 or multi-region ODEs 306, to generate a non-linear ODE 306 for multiple building regions, potentially across multiple buildings. The model generation engine 300 can use a switching function 304 to generate the non-linear ODE 306 for multiple building regions.

The purpose of the group-level thermal model, e.g., generated by the model generation engine 300, can be to enable the demand response control system to estimate the change in aggregated power consumption from a group of HVAC systems controlled by thermostats, relative to a baseline, e.g., counterfactual, power consumption level, given one or more exogenous factors. These exogenous factors can include one or more of: i) weather information, e.g., weather data 322, such as temperature, solar irradiance, humidity, and wind speed; ii) thermostat runtime data 320, e.g., thermostat setpoints, a sequence of changes to thermostat setpoints, or both, e.g., decrease the setpoint by 2 degrees at 15:00, and then decrease the setpoint by 6 degrees at 18:00, then restore the original settings at 20:00; iii) participation data 324, e.g., participation data for past DR events, or a frequency at which a thermostat opts-out of a DR event, or iv) information about the buildings with the thermostats and HVAC systems.

The thermal model can represent, e.g., include, a few elements. First, the thermal model can model an average difference t. The demand response control system might not know the exact setpoint of each individual thermostat, or the temperature inside each building that includes a thermostat, in a thermostat group. To reduce data required for processing, e.g., to reduce the need for extra device-level data, the demand response control system can abstract away the details into a single average temperature difference parameter, e.g., an average difference τ. This can improve efficiency, processing time, or both, for the demand response control system. τ represents the average difference between the indoor, e.g., internal, temperatures inside the buildings for a thermostat group and the setpoint temperature, e.g., τ=T−Tₛₑₜ. Before control begins, e.g., before the DR event begins, the demand response control system can set the average difference t to zero since most HVAC systems will keep the buildings close to the setpoint, with zero average difference across many buildings.

Second, the thermal model can represent the average change in power consumption that would result from a change in t. For example, the demand response control system can use, as part of schedule generation, a predicted answer to questions such as: “how much would average power-consumption change if we increased the setpoint temperature by 4 degrees?” To enable the demand response control system to predict these answers, the demand response control system uses a sigmoid-like function. The sigmoid-like function can be monotonically increasing with t for a cooling system, or monotonically decreasing for a heating system. For cooling or heating systems, this sigmoid-like function can indicate how much power consumption changes as the difference between the setpoint and the indoor temperature increases or decreases. This relationship of how much power consumption changes as the difference between the setpoint and the indoor temperature increases or decreases can have a sigmoidal shape, e.g., that is similar to the logistic function.

Third, the thermal model can model a time-delayed response of the building to increasing or decreasing cooling or heating power. When the temperature changes, the sigmoid-like function can indicate that cooling or heating power will increase or decrease. This power increase or decrease will result in an increase or decrease in indoor temperature, and thus a change in the average difference t, but with a time delay. In some examples, the demand response control system can model this time delay, e.g., in the thermal model, using a first-order, e.g., reduced order, differential equation that is analogous to a resistor (R) capacitor (C) circuit, with a time constant RC. In some instances, the thermal model can include multiple time constants to model more complex time delays.

Using one or more of these elements, the thermal model can combine the sigmoid-like model of the relationship between temperature and power, with a model of the time-delayed relationship between power and temperature. The resulting thermal model can enable the demand response control system to model the impact of various changes to thermostat setpoints on group-level power consumption without the need for detailed device-level models, extensive device-level data, or both.

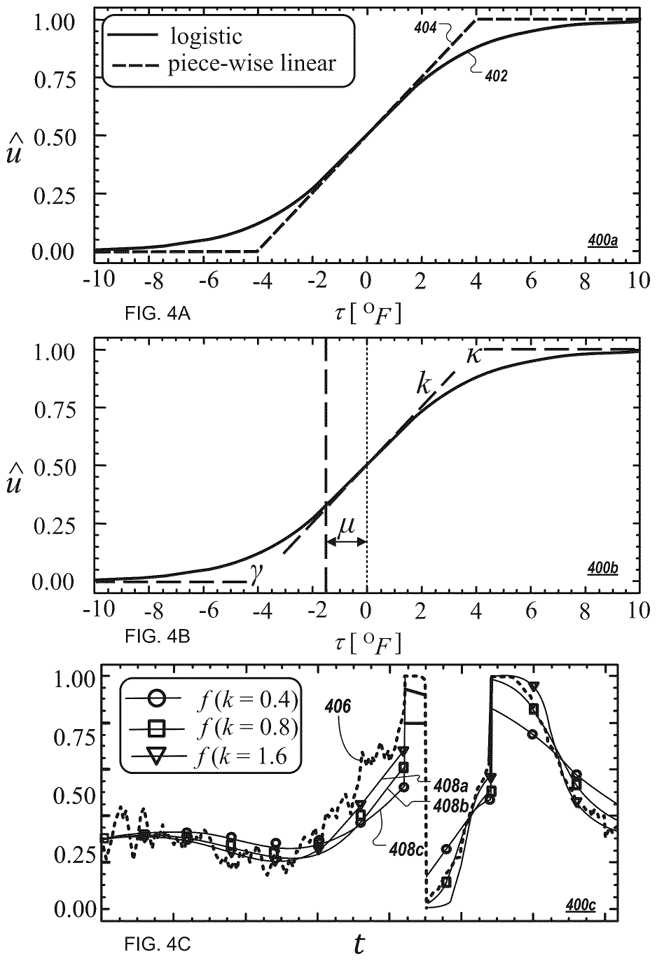

FIG. 4A depicts a graph 400a with examples of switching functions. A switching function can be used to describe the relationship between a relative indoor temperature and a corresponding duty cycle, power output, e.g., HVAC power consumption, or both. In some instances, the switching function can describe the difference between i) the setpoint and actual indoor temperature and ii) duty cycle, power output, or both. The switching function can be a sigmoid-like function, a sigmoid function, or another appropriate switching function. Although some examples described in this specification refer to a sigmoid function, other examples can use other types of functions that are sigmoid-like.

The graph 400a includes a logistic switching function 402, e.g., a non-linear switching function, and a piece-wise linear switching function 404. The logistic switching function 402 is one example of a switching function for the non-linear ODE for multiple building regions. Equation (1), below, is an example of the logistic switching function.

$$f ( θ , τ ) = \frac{( κ - γ )}{1 + {e}^{- k ( τ + μ )}} + γ \qquad ( 1 )$$

In Equation (1), κ is a maximum sigmoid limit; γ is a minimum sigmoid limit; k is a sharpness; τ is an average difference, for one or more thermostats in the thermostat group, between an indoor temperature of a region of a building relative to set point for the respective thermostat for region; and μ is a parameter, e.g., a midpoint shift, that shifts the midpoint of the switching function, e.g., sigmoid. The sharpness k, can indicate, e.g., determine, the slope of the switching function, e.g., sigmoid. In some examples, a higher the value of sharpness k can indicate that the switching function will more quickly change from 0 to 1 than a lower value of the sharpness k.

In Equation (1), θ can include parameters 308, e.g., θ=[k κ γ μ Qₘₐₓ \hat{R} Ĉ \hat{\hat{T}}_{set,0}]. Qₘₐₓ can indicate a connected load power for the thermostat group that corresponds to the multiple building regions. \hat{R} can indicate an average thermal resistance for the thermostat group. Ĉ can indicate an average thermal capacity for the thermostat group. \hat{T}_{set,0} can indicate an average initial reference setpoint for the thermostat group. In some examples, θ can include more or fewer parameters.

The model generation engine 300 can use the non-linear ODE 306 for multiple building regions to generate a discretized linear ODE 312 for multiple building regions. The building regions for the non-linear ODE 306 and the discretized linear ODE 312 are the same building regions, e.g., both ODEs model the same building regions.

The model generation engine 300 can use a piece-wise linear switching function 310 to generate the discretized linear ODE 312 for multiple building regions. The piece-wise linear switching function 404 depicted in the graph 400 is one example of the piece-wise linear function. Use of a linear switching function can improve system control, e.g., determination of a schedule with reduced computational resource usage, e.g., processor cycles, memory, or both; or a combination of these.

The model generation engine 300 can use any appropriate process to linearize the switching function 304 and generate the piece-wise linear switching function 310. For instance, the model generation engine 300 can linearize the switching function 304 around an operating point τ₀ for each time step. In some examples, the model generation engine 300 can linearize the switching function 304 by introducing a static, piece-wise linear approximation to generate the piece-wise linear switching function 310. Equation (2), below, is one example of a piece-wise linear switching function 310.

$$\hat{μ} = \{ \begin{matrix}γ & if τ \leq \frac{( γ - b )}{m} - μ \\ k & if τ \geq \frac{( k - b )}{m} - μ \\ m \cdot τ + b & otherwise\end{matrix} \qquad ( 2 )$$

In Equation (2), b can be the intercept b of the linear segment. One example of the intercept b is shown in Equation (3), below. M can be the slope of the piece-wise linear switching function 310. The model generation engine 300 can use Equation (4), below, to compute the slope m. In some examples, the model generation engine 300 can compute the slope m using the value of the first derivative of Equation (1) at τ=μ.

$$b = \frac{( κ - γ )}{2} + γ \qquad ( 3 )$$

$$m = \frac{k \cdot ( κ - γ )}{4} \qquad ( 4 )$$

The model generation engine 300 can use one or more recurrent neural network training processes to generate the weights 316. For example, the model generation engine 300 can use the discretized linear ODE 312 for multiple building regions, a historical average duty cycle for the thermostats for the multiple building regions, historical HVAC power consumption data, and other appropriate input data, to generate the weights 316.

FIG. 4B depicts an example graph 400b of a switching function. In the graph 400b, dashed lines indicate the maximum sigmoid limit κ at the top, the minimum sigmoid limit γ at the bottom, the sharpness k as a slope for the sigmoid, e.g., the slope at the value of the average difference τ=0, and the midpoint shift μ. The midpoint shift can be any appropriate value for the average difference t between the values for the maximum and minimum sigmoid limits. One or more of these values can be used to compute a piece-wise linear switching function from a logistic switching function.

As part of the training process to generate the weights 316, the model generation engine 300 can use an activation function 318, e.g., the activation function 112 of FIG. 1. The model generation engine 300 can compute the activation function 318 using the piece-wise linear switching function 310. For instance, model generation engine 300 can use the piece-wise linear switching function 310 as the activation function 318 for the training process during which the weights 316 are generated.

FIG. 4C depicts an example graph 400c with a target duty cycle 406 for a thermostat group. A system, e.g., the model generation engine 300 or another component of the demand response control system 102 or another system, can generate the target duty cycle 406 using historical duty cycle data, e.g., the historical data 106a. The model generation engine 300 can train a thermal model using the historical data, e.g., the historical duty cycle data, historical HVAC power consumption data, or a combination of both. For instance, the model generation engine 300 can train the thermal model to simulate the historical duty cycle data given one or more similarity criteria that indicate when to stop the training process. Since the historical data is specific to the devices in the device, e.g., thermostat, group, this “target” is a group specific target in contrast to a target load profile used by the schedule optimizer, e.g., the latter of which is for the target aggregated virtual power plant power consumption for the generated group schedules.

The graph 400c shows how changes to the activation function 318 for the weights 316 change how closely one or more simulated duty cycles 408a-c, generated by a thermal model for a thermostat group, match the target duty cycle 406, e.g., a historical duty cycle for the thermostat group. For instance, as the model generation engine 300 changes the sharpness k during an iterative training process, between values of 0.4, 0.8, and 1.6, the simulated duty cycles 408a-c can more or less closely match the target duty cycle 406.

When the model generation engine 300 determines that one or more training criteria are satisfied, e.g., to stop training, the model generation engine 300 can use the weights 316 as the thermal model for the corresponding thermostat group. The model generation engine 300 can generate one or more other weights for other thermostat groups. The generation of weights for different thermostat groups can occur at least partially concurrently, at least partially in series, or a combination of both.

The weights 316 can represent one or more parameters for the thermostat group. For instance, the weights 316 can represent one or more of a sharpness k, a minimum sigmoid limit γ, a maximum sigmoid limit κ, a midpoint shift μ, a connected load power Qₘₐₓ, an average thermal resistance \hat{R} for the thermostat group, an average thermal capacity Ĉ for the thermostat group, or an average initial reference setpoint \hat{T}_{set,0}, e.g., given a temperature setpoint of the thermostat Tₛₑₜ. Each parameter can be represented by multiple weights. The connected load power Qₘₐₓ can represent the power of the heater, air conditioner, or other type of device, when the device is on.

The thermal resistance R can be a measure of a material's resistance to heat flow, e.g., a material in a region of a building. For instance, when the region is an upper floor in a house, the material can be the walls in the upper floor. The thermal resistance R can be a known value, e.g., determined using sensor data, a predicted value, e.g., given energy data for the building, or a combination of both. In some instances, the thermal resistance R can vary, e.g., significantly, depending on whether the building is well-insulated, indicating a higher resistance, or poorly insulated, indicating a lower resistance.

The thermal capacity C can represent an amount of heat required to change the temperature of the region of the building by one degree, whether Celsius or Fahrenheit. The thermal capacity C can depend on the size of the region, e.g., room or building or another appropriate region; the materials contained within the region; the materials surrounding the region; or any combination of these. The materials contained within the region can include furniture, walls inside the region, and other appropriate materials. The materials surrounding the region can include the walls surrounding the region and other materials that are outside the region but might affect thermal properties of the region. For example, smaller rooms, or those with less thermal mass, will have a lower thermal capacity, whereas larger rooms, or those with more thermal mass, will have larger values.

In some examples, groups of weights can represent separate portions of the switching function 304, e.g., the sigmoid. For instance, a first group of weights can represent a first portion of the sigmoid and a second group of weights can represent a second portion of the sigmoid.

After generating the weights 316, the model generation engine 300 can store the weights 316 in memory, e.g., in a database. The model generation engine 300 can use the weights 316 as part of a schedule optimization process, e.g., described with reference to FIG. 1.

In some examples, a separate system can generate the weights 316 compared to the system that optimizes a schedule. For instance, a training system can generate the weights 316 and provide the weights 316 to the demand response control system that uses the weights 316 for schedule optimization.

The model generation engine 300 can generate the thermal model that includes the weights 316 at any appropriate time. For instance, a demand response control system can receive a message indicating that a DR event is or will occur. In response, the demand response control system can send an instruction to the model generation engine 300 to cause the model generation engine 300 to generate the thermal model that includes the weights 316. This can enable the demand response control system to use a thermal model that might be more accurate than a previously generated thermal model.

In some implementations, the model generation engine 300 generates the thermal model that includes the weights 316 offline, e.g., before receipt of a message indicating that a DR event is or will occur. This can enable the model generation engine 300 to have a model for initial processing, reduce computational resource usage, resource usage when resources might otherwise be limited, or any combination of these. For instance, generating a thermal model offline might result in fewer generations of a thermal model. Generation of a thermal model offline might enable the model generation engine 300 to generate the model when a corresponding system on which the model generation engine 300 is implemented is not performing as many other operations that would be required for a DR event. The model generation engine 300 can generate the thermal model on a schedule, e.g., daily, weekly, or monthly.

The model generation engine 300, or another component of a system, can select the thermostats for a thermostat group in any appropriate manner. For instance, the model generation engine 300 can select the thermostats for a thermostat group to optimize outcomes for the thermostat group, schedule generation, or a combination of both. In some examples, the model generation engine 300 can select the thermostats for a thermostat group using physical geographic locations of the thermostats. This can enable a system to add power grid control limits for a group of thermostats, or other appropriate devices, that sit behind congested, constrained, or both, grid assets. These grid assets can include a feeder, a transmission line, or a transformer, to name a few examples.

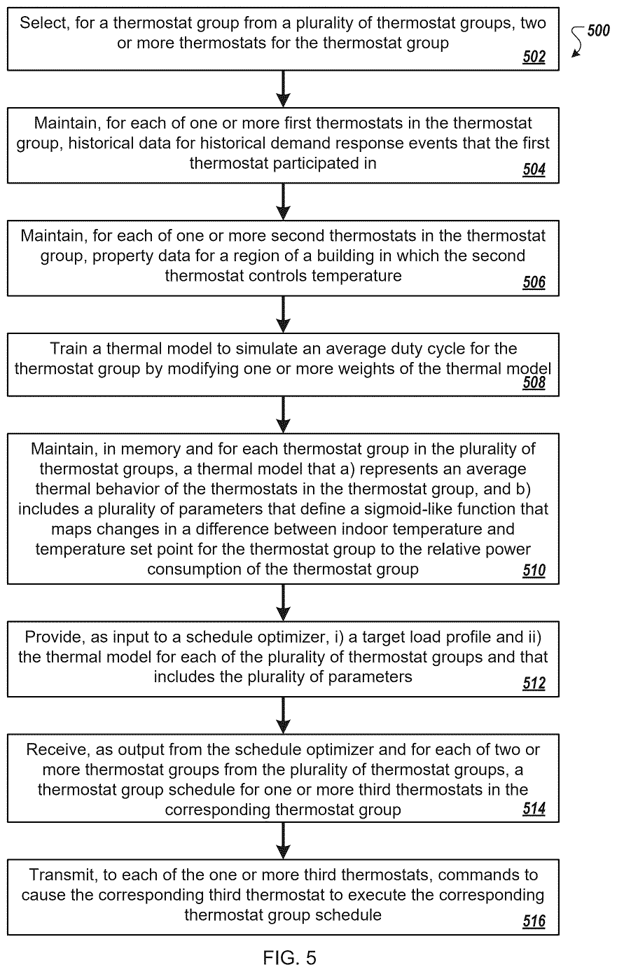

FIG. 5 is a flow diagram of an example process 500 for using a thermal model. For example, the process 500 can be used by the demand response control system 102 from the environment 100.

A demand response control system selects, for a thermostat group from a plurality of thermostat groups, two or more thermostats for the thermostat group (502). As described above, the demand response control system can use any appropriate process to select the two or more thermostats.

The demand response control system maintains, for each of one or more first thermostats in the thermostat group, historical data for historical demand response events that the first thermostat participated in (504). The historical data can include any appropriate type of historical data. The historical data can include historical duty cycle data that indicates one or more historical duty cycles for the first thermostat, an average duty cycle for the first thermostats in the thermostat group, or a combination of both. The historical data can include historical load shed data, historical connected load data, historical weather data, e.g., for a geographic area that includes the thermostat, or any combination of these.

The demand response control system maintains, for each of one or more second thermostats in the thermostat group, property data for a region of a building in which the second thermostat controls temperature (506). For instance, when the demand response control system has access to property data, the demand response system can maintain the property data. In some examples, some of the second thermostats can also be first thermostats in the thermostat group for which historical data is maintained. This can occur when the demand response control system maintains historical data for all thermostats in the thermostat group and maintains property data for only a proper subset of thermostats in the thermostat group.

The demand response control system trains a thermal model to simulate an average duty cycle for the thermostat group by modifying one or more weights of the thermal model (508). The one or more weights of the thermal model can represent parameters included in the thermal model. The demand response control system can train the thermal model using a recurrent neural network training process. The training process can use, as input, the historical data, the property data, other appropriate data, or any combination of these.

In some implementations, the demand response control system trains the thermal model using another appropriate process, e.g., in addition to or instead of using a recurrent neural network training process. The training process can be a machine learning training process. The demand response control system can use a recurrent neural network training process, a least squares regression training process, a genetic algorithm training process, a non-linear mathematical programming training process, an expectation maximization algorithm training process, or any combination of these.

The demand response control system maintains, in memory and for each thermostat group in the plurality of thermostat groups, a thermal model that a) represents an average thermal behavior of the thermostats in the thermostat group, and b) includes a plurality of parameters that define a sigmoid-like function that maps changes in a difference between indoor temperature and temperature set point for the thermostat group to the relative power consumption of the thermostat group (510). For example, after training the thermal model, the demand response control system can store the thermal model in the memory. In implementations in which a separate system trains the thermal model, e.g., performs one or more of operations 502 to 508, the demand response control system can receive the thermal model including the plurality of weights, from the separate system. After receipt, the demand response control system can store, and then maintain, the thermal model in memory.

The demand response control system provides, as input to a schedule optimizer, i) a target load profile and ii) the thermal model for each of the plurality of thermostat groups and that includes the plurality of parameters (512). The schedule optimizer can be any appropriate type of optimizer. The target load profile is a profile for multiple, e.g., all, thermostat groups from the plurality of thermostat groups and is not specific to any particular thermostat group. As a result, the generated thermostat group schedule can have a load profile that is different than the target load profile while the aggregate of all the group schedules is similar to the target load profile. For instance, at least some of the individual group load profiles do not satisfy a similarity criterion for the target load profile while the aggregate of the individual group load profiles satisfies the similarity criterion for the target load profile.

The demand response control system receives, as output from the schedule optimizer and for each of two or more thermostat groups from the plurality of thermostat groups, a thermostat group schedule for one or more third thermostats in the corresponding thermostat group (514). The schedule optimizer need not select the best optimization for the thermostat group schedule. For instance, the schedule optimizer can select a thermostat group schedule, or a system group schedule that includes multiple thermostat group schedules, that is a locally optimized schedule, that satisfies one or more schedule criteria, or a combination of both.

The demand response control system transmits, to each of the one or more third thermostats, commands to cause the corresponding third thermostat to execute the corresponding thermostat group schedule (516). The command can be computer commands, e.g., instructions, that trigger corresponding actions in the receiving third thermostat. For instance, upon receipt, the third thermostat can execute a schedule defined in the commands, including changing a setpoint. The change in setpoint can occur upon receipt or at a time indicated in the commands, e.g., at 17:00 or another appropriate time. When the third thermostat changes its setpoint, the third thermostat can, in response, use the changed setpoint to determine when to transmit one or more instructions to a corresponding heater, air conditioner, other type of HVAC unit, or another appropriate type of device, to cause the receiving device to change a temperature for the controlled region of a building, e.g., when to generate heated air or cooled air. The setpoint change can be a relative setpoint change, e.g., increase or decrease by two degrees.

Optionally, the demand response control system generates using a grouping algorithm, one or more thermostat groups. The demand response control system can generate the one or more thermostat groups by comparing a parameter of a thermostat to a similarity threshold. The demand response control system can group the thermostats into one or more thermostat groups using the results of the comparison. For instance, given results of the comparison with the similarity criterion, the demand response control system can group thermostats that have parameters that satisfy, or do not, the same similarity criterion, e.g., have parameters that are similar. The demand response control system can use the thermostat groups in the operations of the process 500.

The order of operations in the process 500 described above is illustrative only, and the use of the thermal model can be performed in different orders. For example, the process 500 can maintain the historical data and the property data substantially concurrently. In some examples, the process 500 can maintain the property data and then maintain the historical data.

In some implementations, the process 500 can include additional operations, fewer operations, or some of the operations can be divided into multiple operations. For example, the process 500 can include operations 510 through 516, without the other operations. The process 500 can include operations 504, 508, and 510, optionally with one or both of operations 502 or 506.

In this specification, the term “database” is used broadly to refer to any collection of data: the data does not need to be structured in any particular way, or structured at all, and it can be stored on storage devices in one or more locations. A database can be implemented on any appropriate type of memory. A database can maintain corresponding data, e.g., input data 106, schedule criteria 114, or both.

In this specification the term “engine” is used broadly to refer to a software-based system, subsystem, or process that is programmed to perform one or more specific functions. Generally, an engine will be implemented as one or more software modules or components, installed on one or more computers in one or more locations. In some instances, one or more computers will be dedicated to a particular engine. In some instances, multiple engines can be installed and running on the same computer or computers.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform those operations or actions. That one or more computer programs is configured to perform particular operations or actions means that the one or more programs include instructions that, when executed by data processing apparatus, cause the apparatus to perform those operations or actions. That special-purpose logic circuitry is configured to perform particular operations or actions means that the circuitry has electronic logic that performs those operations or actions.

Various values that are described as extreme values, e.g., maximum or minimum values, can be any appropriate type of extreme value. For instance, a maximum or minimum can be a local maximum or minimum value, e.g., and need not be a global value. Accordingly, when a system maximizes the value, the maximum need not be a global maximization but can be a local maximization. Similarly for a minimum value.

A number of implementations have been described. Nevertheless, it will be understood that various modifications can be made without departing from the spirit and scope of the disclosure. For example, various forms of the flows shown above can be used, with operations re-ordered, added, or removed.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, a data processing apparatus. Alternatively or in addition, the program instructions can be encoded on an artificially-generated propagated signal, e.g., a machine-generated electrical, optical, or electromagnetic signal, that is generated to encode information for transmission to a suitable receiver apparatus for execution by a data processing apparatus. One or more computer storage media can include a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can be or include special purpose logic circuitry, e.g., a field programmable gate array (“FPGA”) or an application-specific integrated circuit (“ASIC”). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can be performed by, and apparatus can also be implemented as, special purpose logic circuitry, e.g., a field programmable gate array (“FPGA”) or an application-specific integrated circuit (“ASIC”).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. A computer can be embedded in another device, e.g., a mobile telephone, a smart phone, a headset, a personal digital assistant (“PDA”), a mobile audio or video player, a game console, a Global Positioning System (“GPS”) receiver, or a portable storage device, e.g., a universal serial bus (“USB”) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a liquid crystal display (“LCD”), an organic light emitting diode (“OLED”) or other monitor, for displaying information to the user and a keyboard and a pointing device, e.g., a mouse or a trackball or a touchscreen, by which the user can provide input to the computer. Other kinds of devices can be used to provide for interaction with a user as well. For example, feedback provided to the user can be any form of sensory feedback, e.g., visual feedback, auditory feedback, or tactile feedback; and input from the user can be received in any form, including acoustic, speech, or tactile input. In some examples, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an Hypertext Markup Language (“HTML”) page, to a user device, e.g., for purposes of displaying data to and receiving user input from a user device, which acts as a client. Data generated at the user device, e.g., a result of user interaction with the user device, can be received from the user device at the server.

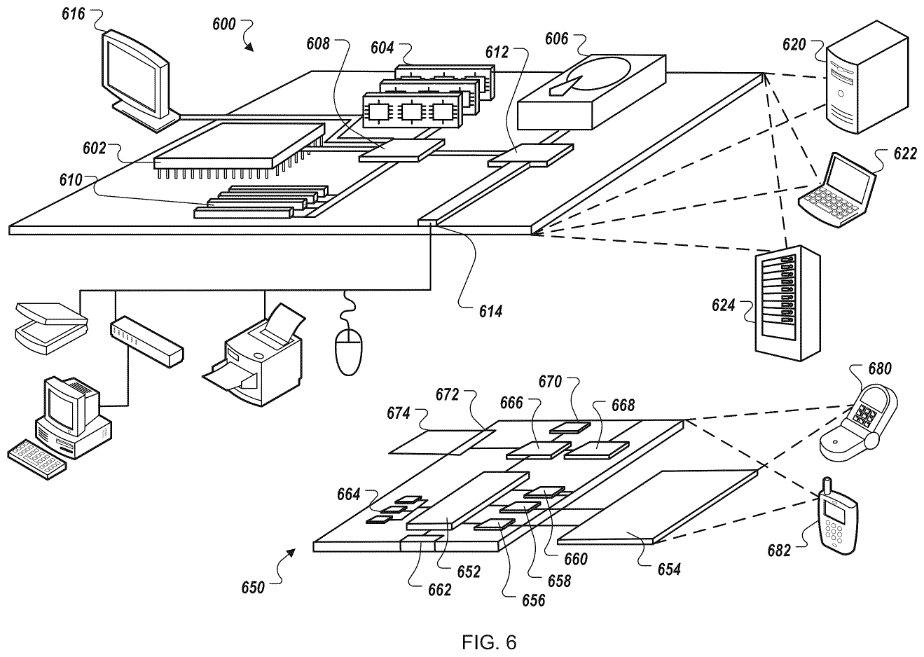

FIG. 6 is a block diagram of computing devices 600, 650 that may be used to implement the systems and methods described in this specification, as either a client or as a server or plurality of servers. Computing device 600 is intended to represent various forms of digital computers, such as laptops, desktops, workstations, personal digital assistants, servers, blade servers, mainframes, and other appropriate computers. Computing device 650 is intended to represent various forms of mobile devices, such as personal digital assistants, cellular telephones, smartphones, smartwatches, head-worn devices, and other similar computing devices. The components shown here, their connections and relationships, and their functions, are meant to be exemplary only, and are not meant to limit implementations described and/or claimed in this specification.

Computing device 600 includes a processor 602, memory 604, a storage device 606, a high-speed interface 608 connecting to memory 604 and high-speed expansion ports 610, and a low speed interface 612 connecting to low speed bus 614 and storage device 606. Each of the components 602, 604, 606, 608, 610, and 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as display 616 coupled to high speed interface 608. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 604 stores information within the computing device 600. In one implementation, the memory 604 is a computer-readable medium. In one implementation, the memory 604 is a volatile memory unit or units. In another implementation, the memory 604 is a non-volatile memory unit or units.

The storage device 606 is capable of providing mass storage for the computing device 600. In one implementation, the storage device 606 is a computer-readable medium. In various different implementations, the storage device 606 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 604, the storage device 606, or memory on processor 602.

The high speed controller 608 manages bandwidth-intensive operations for the computing device 600, while the low speed controller 612 manages lower bandwidth-intensive operations. Such allocation of duties is exemplary only. In one implementation, the high-speed controller 608 is coupled to memory 604, display 616 (e.g., through a graphics processor or accelerator), and to high-speed expansion ports 610, which may accept various expansion cards (not shown). In the implementation, low-speed controller 612 is coupled to storage device 606 and low-speed expansion port 614. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. It may also be implemented as part of a rack server system 624. In addition, it may be implemented in a personal computer such as a laptop computer 622. Alternatively, components from computing device 600 may be combined with other components in a mobile device (not shown), such as device 650. Each of such devices may contain one or more of computing device 600, 650, and an entire system may be made up of multiple computing devices 600, 650 communicating with each other.

Computing device 650 includes a processor 652, memory 664, an input/output device such as a display 654, a communication interface 666, and a transceiver 668, among other components. The device 650 may also be provided with a storage device, such as a microdrive or other device, to provide additional storage. Each of the components 650, 652, 664, 654, 666, and 668, are interconnected using various buses, and several of the components may be mounted on a common motherboard or in other manners as appropriate.

The processor 652 can process instructions for execution within the computing device 650, including instructions stored in the memory 664. The processor may also include separate analog and digital processors. The processor may provide, for example, for coordination of the other components of the device 650, such as control of user interfaces, applications run by device 650, and wireless communication by device 650.

Processor 652 may communicate with a user through control interface 658 and display interface 656 coupled to a display 654. The display 654 may be, for example, a TFT LCD display or an OLED display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may be provided in communication with processor 652, so as to enable near area communication of device 650 with other devices. External interface 662 may provide, for example, for wired communication (e.g., via a docking procedure) or for wireless communication (e.g., via Bluetooth or other such technologies).

The memory 664 stores information within the computing device 650. In one implementation, the memory 664 is a computer-readable medium. In one implementation, the memory 664 is a volatile memory unit or units. In another implementation, the memory 664 is a non-volatile memory unit or units. Expansion memory 674 may also be provided and connected to device 650 through expansion interface 672, which may include, for example, a SIMM card interface. Such expansion memory 674 may provide extra storage space for device 650, or may also store applications or other information for device 650. Specifically, expansion memory 674 may include instructions to carry out or supplement the processes described above, and may include secure information also. Thus, for example, expansion memory 674 may be provided as a security module for device 650, and may be programmed with instructions that permit secure use of device 650. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 664, expansion memory 674, or memory on processor 652.

Device 650 may communicate wirelessly through communication interface 666, which may include digital signal processing circuitry where necessary. Communication interface 666 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 668. In addition, short-range communication may occur, such as using a Bluetooth, WiFi, or other such transceiver (not shown). In addition, GPS receiver module 670 may provide additional wireless data to device 650, which may be used as appropriate by applications running on device 650.

Device 650 may also communicate audibly using audio codec 660, which may receive spoken information from a user and convert it to usable digital information. Audio codec 660 may likewise generate audible sound for a user, such as through a speaker, e.g., in a handset of device 650. Such sound may include sound from voice telephone calls, may include recorded sound (e.g., voice messages, music files, etc.) and may also include sound generated by applications operating on device 650.

The computing device 650 may be implemented in a number of different forms, as shown in the figure. For example, it may be implemented as a cellular telephone 680. It may also be implemented as part of a smartphone 682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

In some implementations, when a device or system transmits data to another device or system, the transmission of the data, such as a message, can cause the other device or system to perform one or more actions. For instance, transmission of a message that includes an instruction to a camera can cause the camera to capture one or more images, transmit one or more images to the device or system, or a combination of both.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some instances be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the invention have been described. Other implementations are within the scope of the following claims. For example, the operations recited in the claims, described in the specification, or depicted in the figures can be performed in a different order and still achieve desirable results. In some implementations, multitasking and parallel processing may be advantageous.

1. A computer-implemented method comprising:
maintaining, in memory and for each thermostat group in a plurality of thermostat groups, a thermal model that a) represents an average thermal behavior of thermostats in the thermostat group, and b) includes a plurality of parameters that define a sigmoid-like function that maps changes in a difference between indoor temperature and temperature set point for the thermostat group to a relative power consumption of the thermostat group;
providing, as input to a schedule optimizer, i) a target load constraint for multiple thermostat groups from the plurality of thermostat groups and ii) the thermal model for each of the plurality of thermostat groups and that includes the plurality of parameters;
receiving, as output from the schedule optimizer and for each of two or more thermostat groups from the plurality of thermostat groups, a thermostat group schedule for one or more thermostats in the corresponding thermostat group; and
in response to receiving the thermostat group schedule, transmitting, to each of the one or more thermostats, commands to cause the corresponding thermostat to execute the corresponding thermostat group schedule.

2. The method of claim 1, wherein:
providing the input to the schedule optimizer comprises providing, as input to the schedule optimizer, controllability data that identifies a controllability of at least some of the thermostats in the plurality of thermostat groups; and
receiving the thermostat group schedule comprises receiving the thermostat group schedule that was generated using the controllability data.

3. The method of claim 1, wherein, for at least a first thermostat group from the plurality of thermostat groups, the plurality of parameters that define the sigmoid-like function of the thermal model define a sigmoid approximation of the relative power consumption of the thermostat group as a function of:
an average difference t, for two or more thermostats in the thermostat group, between an indoor temperature of a region of a building relative to set point for the respective thermostat for the region;
a sharpness k;
a minimum sigmoid limit γ; and
a maximum sigmoid limit κ.

4. The method of claim 3, comprising generating, as the thermal model and using a piece-wise linear switching function as the sigmoid approximation of the relative power consumption, a reduced-order, linearized thermal model.

5. The method of claim 4, wherein generating the thermal model comprises generating, using a recurrent neural network training process, the plurality of parameters of the thermal model represented by one or more weights.

6. The method of claim 1, wherein the thermal model, a) for a thermostat group from the plurality of thermostat groups and b) that includes the plurality of parameters, was trained using property data for a proper subset of thermostats in the thermostat group that does not include all thermostats in the thermostat group.

7. The method of claim 1, wherein the thermal model, a) for a thermostat group from the plurality of thermostat groups and b) that includes the plurality of parameters, was trained using historical data for a proper subset of thermostats in the thermostat group that does not include all thermostats in the thermostat group.

8. The method of claim 7, wherein the historical data includes setpoint data for one or more first thermostats in the thermostat group and does not include setpoint data for one or more second, different thermostats in the thermostat group.

9. The method of claim 1, wherein:
providing the input to the schedule optimizer comprises providing, as the input to the schedule optimizer, i) the target load constraint for the multiple thermostat groups, ii) the thermal model for each of the plurality of thermostat groups and that includes the plurality of parameters, and iii) one or more non-thermostat device group models; and
receiving the output comprises receiving, as the output from the schedule optimizer and for each of the two or more thermostat groups from the plurality of thermostat groups, a thermostat group schedule.

10. The method of claim 1, comprising generating, using a grouping algorithm, the thermostat groups of the plurality of thermostat groups by:
comparing, for each of at least some thermostats from a plurality of thermostats, a parameter of the corresponding thermostat to a similarity threshold, and,
grouping, using a result of the comparing, a two or more thermostats from the plurality of thermostats into a thermostat group of the plurality of thermostat groups.

11. The method of claim 10, wherein the parameter of the plurality of thermostats comprises a runtime trend during prior DR events, an amount of time that a measured indoor temperature takes to go from a person setpoint value to a new setpoint after a DR event, or a frequency at which a thermostat opts-out of a DR event

12. The method of claim 1, comprising providing, as input to the schedule optimizer, iii) a cost term representing a difficulty of one or more thermostat groups to satisfy an objective of the target load constraint, and wherein the schedule optimizer generates the thermostat group schedule by determining a minimum of the cost term which satisfies the objective.

13. The method of claim 1, wherein the plurality of parameters comprising one or more of a sharpness k, a minimum sigmoid limit γ, a maximum sigmoid limit κ, a midpoint shift μ that shifts the midpoint of a switching function for the thermal model, a connected load power Qₘₐₓ, an average thermal resistance \hat{R} for the thermostat group, an average thermal capacity Ĉ for the thermostat group, or an average initial reference setpoint \hat{T}_{set,0} for the thermostat group.

14. The method of claim 13, wherein the one or more thermostats comprise one or more first thermostats, the method comprising:
for each thermostat group of a plurality of thermostat groups:
maintaining, for each of one or more second thermostats in the thermostat group, historical data for historical demand response events that the second thermostat participated in and includes historical relative power consumption data that indicates one or more historical relative power consumption cycles for the second thermostat;
training the thermal model to simulate an average relative power consumption for the thermostat group using, as input, the historical data by modifying the plurality of parameters of the thermal model; and
storing, in memory, the plurality of parameters as the thermal model that a) represents the average thermal behavior of the thermostats in the thermostat group, and b) includes the plurality of parameters that define the sigmoid-like function and were generated using a training process.

15. The method of claim 14, wherein training the thermal model comprises training the thermal model that has, for one or more nodes representing a parameter from the plurality of parameters included in the thermal model, an activation function based on a combination of the sharpness k, the minimum sigmoid limit γ, the maximum sigmoid limit κ, and the midpoint shift μ.

16. The method of claim 15, wherein the activation function is based on, as input, at least some of the plurality of parameters and τ=T−Tₛₑₜ for an indoor temperature T of a region of a building and a thermostat setpoint Tₛₑₜ.

17. The method of claim 14, comprising selecting, for a thermostat group from the plurality of thermostat groups, two or more thermostats for the thermostat group using, for each of the two or more thermostats, a physical location of corresponding thermostat.

18. The method of claim 14, comprising:
maintaining, for each of one or more third thermostats in the thermostat group, property data for a region of a building in which the third thermostat controls temperature, wherein training the thermal model uses the property data as input.

19. One or more computer storage media encoded with instructions that, when executed by one or more computers, cause the one or more computers to perform operations comprising:
maintaining, in memory and for each thermostat group in a plurality of thermostat groups, a thermal model that a) represents an average thermal behavior of thermostats in the thermostat group, and b) includes a plurality of parameters that define a sigmoid-like function that maps changes in a difference between indoor temperature and temperature set point for the thermostat group to a relative power consumption of the thermostat group;
providing, as input to a schedule optimizer, i) a target load constraint for multiple thermostat groups from the plurality of thermostat groups and ii) the thermal model for each of the plurality of thermostat groups and that includes the plurality of parameters;
receiving, as output from the schedule optimizer and for each of two or more thermostat groups from the plurality of thermostat groups, a thermostat group schedule for one or more thermostats in the corresponding thermostat group; and
in response to receiving the thermostat group schedule, transmitting, to each of the one or more thermostats, commands to cause the corresponding thermostat to execute the corresponding thermostat group schedule.

20. A system comprising one or more computers and one or more storage devices on which are stored instructions that are operable, when executed by the one or more computers, to cause the one or more computers to perform operations comprising:
maintaining, in memory and for each thermostat group in a plurality of thermostat groups, a thermal model that a) represents an average thermal behavior of thermostats in the thermostat group, and b) includes a plurality of parameters that define a sigmoid-like function that maps changes in a difference between indoor temperature and temperature set point for the thermostat group to a relative power consumption of the thermostat group;
providing, as input to a schedule optimizer, i) a target load constraint for multiple thermostat groups from the plurality of thermostat groups and ii) the thermal model for each of the plurality of thermostat groups and that includes the plurality of parameters;
receiving, as output from the schedule optimizer and for each of two or more thermostat groups from the plurality of thermostat groups, a thermostat group schedule for one or more thermostats in the corresponding thermostat group; and
in response to receiving the thermostat group schedule, transmitting, to each of the one or more thermostats, commands to cause the corresponding thermostat to execute the corresponding thermostat group schedule.
